(19) United States
(12) Patent Application Publication
(10) Pub. No.: US 2014/0098142 A1
(43) Pub. Date: Apr. 10, 2014

(54) SYSTEM AND METHOD FOR GENERATION AND MANIPULATION OF A CURVE IN A DYNAMIC GRAPH BASED ON USER INPUT

(71) Applicant: School Yourself, Inc., Boston, MA (US)

(72) Inventors: John J. Lee, Long Island City, NY (US); Zachary D. Wissner-Gross, Boston, MA (US); Kenny Peng, Long Island City, NY (US); Vivek Venkatachalam, Cambridge, MA (US)

(73) Assignee: SCHOOL YOURSELF, INC., Boston, MA (US)

(21) Appl. No.: 14/049,905

(22) Filed: Oct. 9, 2013

Related U.S. Application Data
(60) Provisional application No. 61/711,441, filed on Oct. 9, 2012.

(51) Int. Cl. G06F 3/0484; G06F 3/0488; G06T 11/20

(52) U.S. Cl. CPC G06F 3/04845; G06T 11/206; G06F 3/0488
USPC 345/676

(57) ABSTRACT

A system and method for generating and manipulating one or more curves in a dynamic graph in response to user input. The system provides a user interface for interacting with (e.g. manipulating) curves in a dynamic graph of a drawing program. In response to user input (e.g. interaction with the graph and/or curve therein), the user interface graphically generates and/or modifies the curve. Generation/modification of the curve is based on an algorithm configured to intuitively and dynamically move control points of the curve in response to the user input. The user input may include direct interaction with portions of the curve itself, as well as direct control of the end points and/or control points. The algorithm ensures that the generated/modified curve represents a valid mathematical function, while further ensuring that the generated or modified curve appears visually smooth.

### CROSS-REFERENCE TO RELATED APPLICATIONS

The present application claims priority to, and the benefit of, U.S. Provisional Patent Application Ser. No. 61/711,441, filed Oct. 9, 2012 and titled SYSTEMS FOR CREATING DYNAMIC GRAPHS WITH A TOUCH OR MOUSE INTERFACE, the entire disclosure of which is incorporated herein by reference.

### FIELD

The present disclosure relates generally to mathematical functions, and, more particularly, to a system and method for generating and manipulating one or more curves in a dynamic graph in response to user input.

### BACKGROUND

The use of computing devices for rendering images, graphics, and the like has become common in a variety of professions. For example, artists, draft persons, engineers, and architects regularly use computers for generating drawings and figures related to their professional services. There are currently a variety of different drawing applications and programs that allow a user to create and generate drawings, graphics, animations and the like. Generally, current drawing applications provide users with a variety of drawing options, from basic features (e.g., straight lines, freeform lines, curves, arches, square, circle, etc.) to animation features (providing movement to one or more portions of a drawing).

In some instances, a user may wish to manipulate one or more portions of a drawing. For example, a user may wish to interact with a curve to change certain properties of the curve (e.g., make a portion of the curve more round, more straight, etc.). However, most users do not understand or appreciate the complexities of a curve. Unlike a straight line, a curve is a visual representation of a mathematical expression that is much more complex. A user may have little or no knowledge of the mathematics that define a curve and, instead, are only interested in the ability of a drawing program to provide an intuitive and relatively simple means of modifying the curve to their specifications.

In one example, a user may need to define an arbitrary curve. The user may not want a particular, known curve, easily defined by a common formula, such as a circle, ellipse, or parabola. Instead, the user may require flexibility to represent exactly what is mentally envisioned. The user may want a curve that is far more sophisticated than a simple circular arc, or segment of an ellipse. In the end, a user may desire an irregular, yet smoothly undulating, curve.

Current drawing programs may allow a user to manipulate curves. For example, some drawing programs allow users to create and interact with Bezier curves. A Bezier curve is defined as a pair of endpoints along with a corresponding pair of control points, which define the behavior of the curve near the endpoints. FIG. 1 illustrates a variety of different Bezier curves created by conventional drawing programs. As shown in FIG. 1, Bezier curves change their shape depending on the position of the control points. For example, curves (A)-(E) show a single cubic Bezier path segment, while curve (F) shows a “C” command followed by an “S” command. While it is possible to manipulate the shape of Bezier curves by moving the endpoints or the control points, manipulation of these curves is not a very intuitive interface because users do not actually manipulate the curve based on direct interaction with the curve, but rather points on the end, or control points that do not lie on the curve itself. Additionally, it is still possible to create invalid curves with current drawing programs (e.g., curve (B) is not a valid mathematical function). Accordingly, current drawing programs lack ability to receive user input and generate a resulting curve to be a smooth, continuous mathematical function upon manipulation from the user.

### BRIEF DESCRIPTION OF THE DRAWINGS

Features and advantages of the claimed subject matter will be apparent from the following detailed description of embodiments consistent therewith, which description should be considered with reference to the accompanying drawings, wherein:

FIG. 1 illustrates a variety of different Bezier curves created by conventional drawing applications and programs.

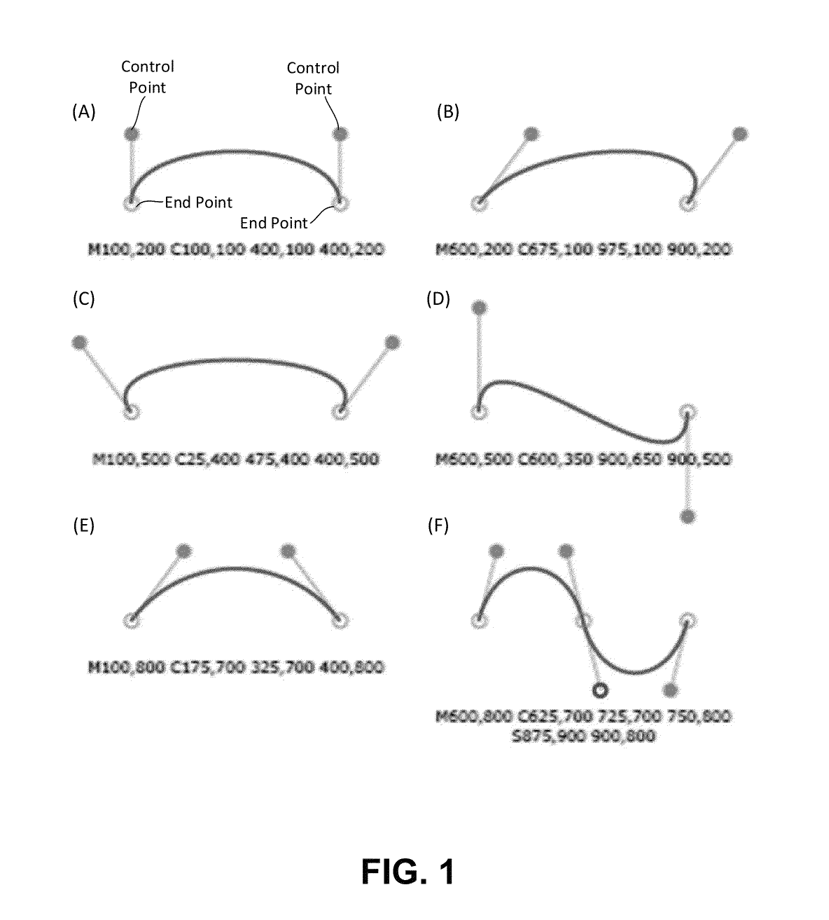

FIG. 2 illustrates a block diagram of a system including a user interface for allowing user interaction with one or more curves in a dynamic graph.

FIG. 3 illustrates an exemplary method of modifying a curve from a first configuration to a second configuration in response to user input consistent with various embodiments of the present disclosure.

FIG. 4 illustrates the transition of the curve of FIG. 3 from the first to the second configuration.

FIG. 5 illustrates an exemplary method of modifying the curve of FIG. 3 from the first configuration to a third configuration in response to user input consistent with various embodiments of the present disclosure.

FIG. 6 illustrates the transition of the curve of FIG. 3 from the first configuration to the third configuration.

FIG. 7 is a graphic representation of control points of a curve of a dynamic graph consistent with the present disclosure.

FIG. 8 is a screenshot of a user interface of a drawing program allowing a user to interact with and manipulate a curve in a dynamic graph according to a method consistent with the present disclosure.

### DETAILED DESCRIPTION

By way of overview, the present disclosure is generally directed to a system and method for generating and manipulating one or more curves in a dynamic graph in response to user input. A system consistent with the present disclosure generally provides a user interface for use in a drawing program. The user interface provides a user with one or more tools for interacting with (e.g. manipulate) curves in a dynamic graph of the drawing program. In response to user input (e.g. interaction with a curve), the user interface graphically generates and/or modifies the curve. Generation/modification of the curve is based on an algorithm configured to intuitively and dynamically move control points of the curve in response to the user input. The user input may include direct interaction with end points and/or control points of the curve. Additionally, the user input may further include direct interaction with portions of the curve itself and is thus not limited to only direct control of the end points and/or control points. The algorithm ensures that the generated/modified curve represents a valid mathematical function, while further ensuring that the generated or modified curve appears visually smooth. For example, the algorithm is configured to ensure that the curve is continuous and remains smooth during user interaction with the curve.

A system consistent with the present disclosure provides a user interface that addresses and overcomes the drawbacks of conventional drawing program interfaces. In particular, the system provides an intuitive interface configured to render a continuous, smooth, mathematically valid functions based on user interaction with any aspect of a curve, including specific portions of the curve itself, in addition to direct interaction with the control points and/or endpoints. The term “valid”, as used herein with reference to mathematical functions, is that for any x-coordinate on a graph of a curve, there is only one corresponding y-coordinate. That is, if a vertical line were to be drawn anywhere along the curve, it would intersect the curve at no more than one point. Accordingly, the user interface consistent with the present disclosure allows modification of curves in response to direct user input with the curve (e.g. dragging specific portions of curve) while ensuring that the curve is continuous, remains smooth and represents a valid mathematical function during user interaction. Furthermore, the user interface allows a user to perform additional operations on a curve without changing the graph itself. Furthermore, the user interface is intuitive as it allows users to draw entire curves with a single motion, as well as make small adjustments in specific locations.

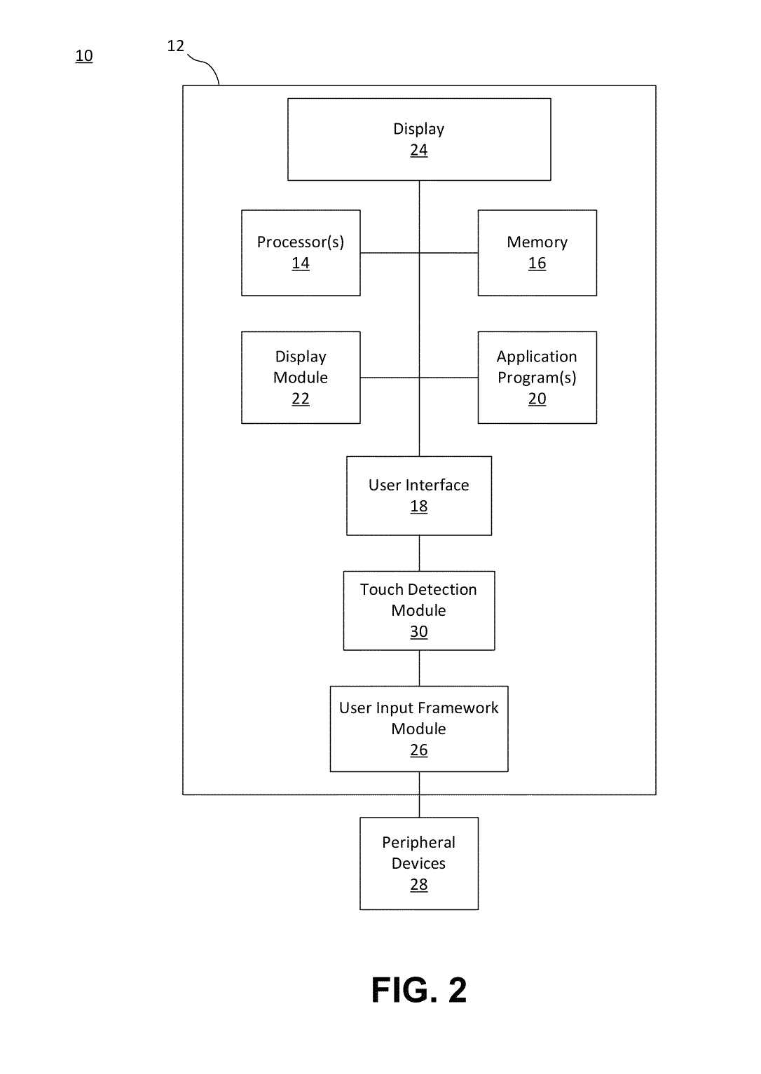

Turning to FIG. 2, one embodiment of a system including a user interface for allowing user interaction with one or more curves in a dynamic graph is generally illustrated. As shown, the system 10 includes a computing device 12. As described in greater detail herein, the computing device 12 is configured to provide a user with an interface for interacting with one or more programs, such as, for example, a drawing program, executed and run on the computing device 12. The computing device 12 may include, but is not limited to, a personal computer (PC) (e.g. desktop or notebook computer), a television, video monitor, electronic billboard, tablet computer, smart phone (e.g., iPhones®, Android®-based phones, Blackberries®, Symbian®-based phones, Palm®-based phones, etc.), portable video game device, portable digital assistant (PDA), portable media player (PMP), e-book, and other computing device.

In the illustrated embodiment, the computing device 12 includes a processor 14, memory 16, a user interface 18, application program(s) 20, display module 22, a display 24, a user input framework module 26, a touch detection module 30, and one or more peripheral devices 28. As generally understood, the computing device 12 may include fewer, other, or additional components, such as those commonly found in conventional computer systems. Additionally, in some embodiments, one or more of the illustrative components may be incorporated in, or otherwise from a portion of, another component. For example, the memory 16, or portions thereof, may be incorporated into the processor 14 in some embodiments.

The processor 14 may be embodied as any type of processor capable of performing the functions described herein. For example, the processor may be embodied as a single or multi-core processor(s), digital signal processor, microcontroller, or other processor or processing/controlling circuit. Similarly, the memory 16 may be embodied as any type of volatile or non-volatile memory or data storage capable of performing the functions described herein. In operation, the memory 16 may store various data and software used during operation of the computing device 12 such as operating systems, applications, programs, libraries, and drivers. The memory 16 is communicatively coupled to the processor 14 via an I/O subsystem (not shown), for example, which may be embodied as circuitry and/or components to facilitate input/output operations with the processor 14, the memory 16, and other components of the computing device 12.

The computing device 12 may also include data storage (not shown). The data storage may be embodied as any type of device or devices configured for short-term or long-term storage of data such as, for example, memory devices and circuits, memory cards, hard disk drives, solid-state drives, or other data storage devices. The computing device 12 may maintain one or more application programs, databases, media and/or other information in the data storage.

The user interface 18 is configured to allow a user of device 12 to interact with application programs 20 running on the device 12. The application program(s) 20 may include any number of different software application programs, each configured to execute a specific task. For the purpose of this disclosure, the application program may include a drawing program, for example. The user interface 18 may be configured to allow a user to control one or more parameters of a running application via user input. The display module 22 may be configured to display the user interface of one or more applications on the display 24. The display 24 may include any device configured to display text, still images, moving images (e.g., video), user interfaces, graphics, dynamic graphs, etc. The display 24 may be integrated within the device 12, as shown, or may interact with the device 12 via wired or wireless communication.

The user interface 18 is configured to receive user input to allow the user to navigate and interact with a running application program, such as drawing program. More specifically, the user interface 18 provides the user with one or more tools for interacting with (e.g. manipulate) curves in a dynamic graph of the drawing program as presented on the display 24.

As generally understood, the display 24 may be a touch-sensitive display configured to allow a user to provide user input via one or more touch events corresponding to a graphical user-interface (GUI) of the device 12 presented on the display 24. The user input framework module 26 may include custom, proprietary, known and/or after-developed user input code (or instruction sets) that are generally well-defined and operable to control the touchscreen display 24. For example, the user input framework module 26 may cause the touchscreen display 24 to record touches and may process touches. The user input framework module 26 may vary depending on device 12, and more particularly, the operating system (OS) running in device 12. Example operating systems include iOS®, Android®, Blackberry® OS, Symbian®, Palm® OS, etc.

The touch detection module 30 is configured to receive touch data from the user input framework module 26 and to identify the touch event based on the received touch data and generate touch input data. The touch event identifier may include touch type and/or touch location(s) of the touchscreen display 24. Touch type may include a single tap, a double tap, a tap and hold, a tap and move, a pinch and stretch, a swipe, etc., to the display 24. The touch detection module 30 may include custom, proprietary, known and/or after-developed touch detection code (or instruction sets) that are generally well-defined and operable to receive touch data and to identify a touch event.

Additionally, or alternatively, the user input framework module 26 is configured to receive input data from one or more peripheral devices 28 for interaction with the user interface 18. The peripheral devices 28 may include, but are not limited to, a keypad, a keyboard, and a mouse. For the purposes of discussion, the peripheral device 28 is a mouse. As described in greater detail, a user may navigate the user interface 18 by way of input from the mouse 28 (e.g., via left-click, right-click, scroll, etc.). The user input framework module 26 is configured to transmit the input data from the mouse 28 to the user interface 18, thereby allowing a user to navigate and/or manipulate a drawing program GUI presented on the display 24 based on the input data.

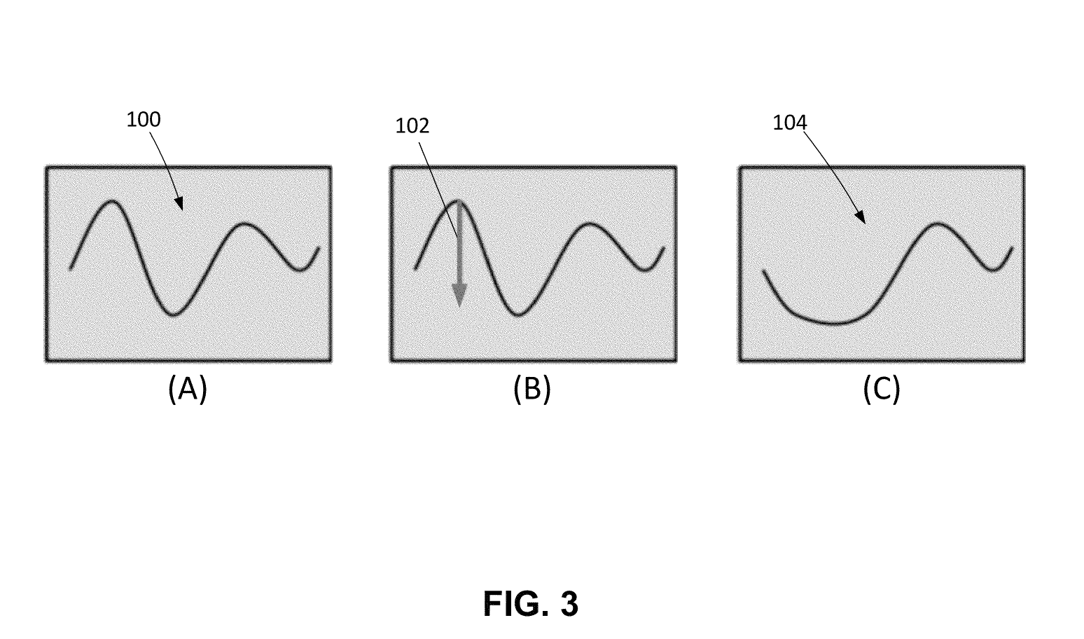

Turning to FIG. 3, an exemplary method of modifying a curve from a first configuration to a second configuration in response to user input is illustrated. As previously described, the user interface 18 is configured to allow a user of device 12 to interact with a drawing program running on the device 12. In particular, the drawing program may provide a dynamic graph including a curve therein. The user interface 18 is configured to allow a user to directly interact with the curve so as to manipulate the curve from one configuration to another.

As shown in FIG. 3(A), an initial graph is presented (via display 24) to a user, wherein the graph includes a curve having a first configuration 100. The user may wish to manipulate the curve so as to change the shape of the curve. FIG. 3(B) shows user input 102 with a specific portion of the curve (shown by poi, as represented by the downward arrow. Upon receiving the user input 102, the user interface is configured to modify the curve from the first configuration 100 to the second configuration 104, shown in FIG. 3(C).

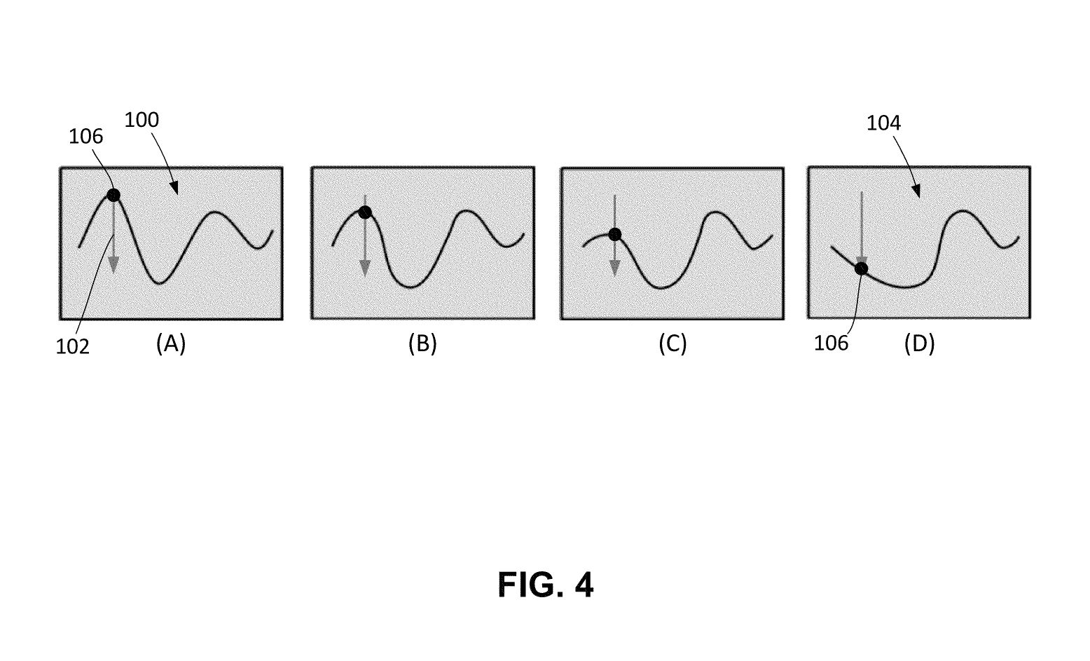

FIG. 4 illustrates the transition of the curve of FIG. 3 from the first to the second configurations (100, 104) in greater detail. As shown, the user may interact with the curve and provide a downward movement to the particular portion of the curve. As previously described herein, user input may be in the form of touch input, such that the user selects a specific portion of the curve and applies a swiping motion to the touch-sensitive display 24, so as to manipulate the curve. Additionally, or alternatively, user input may be in the form of input from a mouse 28, such that the user clicks a specific portion of the curve and drags the mouse in a desired direction (e.g. downward drag) so as to manipulate the curve.

As shown in FIG. 4(A), the user selects a specific portion of the curve (shown at 106) when in the first configuration 100 and begins to manipulate the curve (vertical movement at arrow 102). FIGS. 4(B) and (C) illustrate modification of the curve based on the user input (vertical downward movement). FIG (D) shows the curve in the second configuration 104 at the end of the user input. As shown, the user interface 18 allows modification of the curve from the first configuration 100 to the second configuration 104 in response to direct user input with the curve (e.g. dragging specific portion of curve 106) while ensuring that the curve is continuous, remains smooth and represents a valid mathematical function during user interaction.

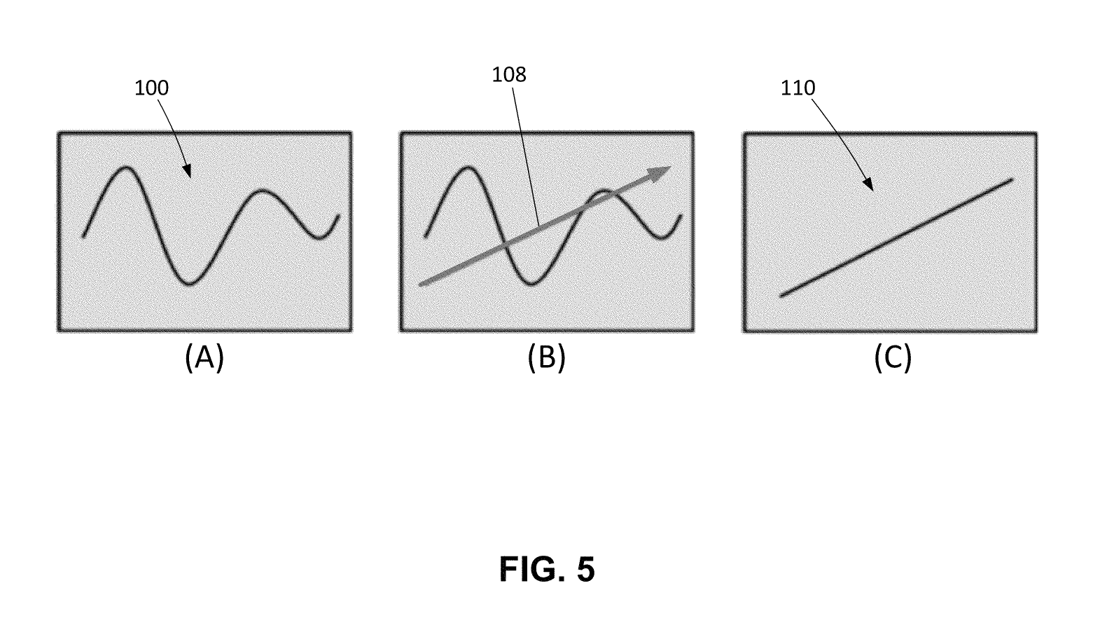

Turning to FIG. 5, an exemplary method of modifying the curve of FIG. 3 from the first configuration to a third configuration in response to user input is illustrated. Unlike the user interaction illustrated in FIGS. 3 and 4 (user selects a specific portion 106 of the graph, the user may select an area of the graph and perform an action (e.g. swipe) across a portion of the graph and/or curve so as to manipulate the curve. As shown in FIG. 5(A), an initial graph is presented to the user, wherein the graph includes a curve having a first configuration 100. FIG. 5(B) shows user input 108 with the curve, as represented by the angled upward arrow. Upon receiving the user input 108, the user interface is configured to modify the curve from the first configuration 100 to the third configuration 110, shown in FIG. 5(C).

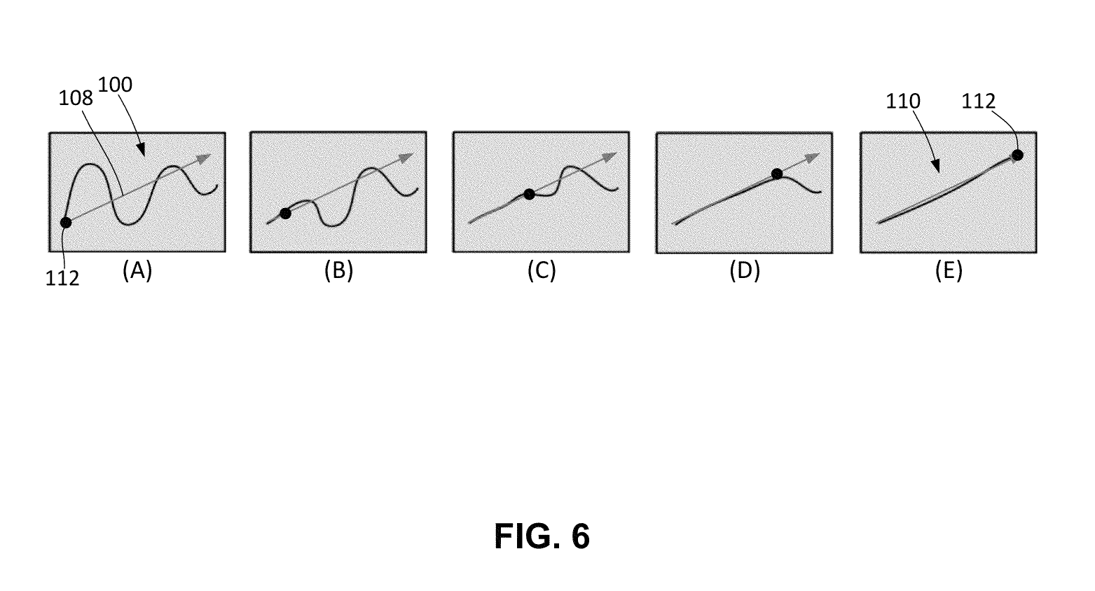

FIG. 6 illustrates the transition of the curve of FIG. 3 from the first to the third configurations (100, 110) in greater detail. As shown, the user may interact with the curve and provide an angled upward movement to the overall curve. As shown in FIG. 6(A), the user may select a portion of the graph or curve (shown at 112) when in the first configuration 100 and begins to manipulate the curve (angled upward movement at arrow 108). FIGS. 4(B) and (C) illustrate modification of the curve based on the user input (angled upward movement). FIG (D) shows the curve in the third configuration 110 at the end of the user input. As shown, a user may swipe across the entire curve and the user interface is configured to modify the entire curve to correspond to the user's input (angled upward movement).

It should be noted that a user may utilize both forms of curve manipulation interchangeably. For example, a user may drag their finger across the screen in a straight line to produce a straight line, but then may select and drag a middle portion of the resulting line vertically, resulting in a curve that is mostly straight with a bump in the middle. Users do not need to switch to a different “mode” in order to access this behavior.

The user interface relies on an algorithm for achieving the curve manipulations shown and described with reference to FIGS. 3-6. As part of the algorithm, a curve is described by a set of control points. In our case, these control points are (x, y) coordinate pairs, and all of those points are guaranteed to be on the curve. In some embodiments, the control points are not displayed to the user. Rather, the control points are used to represent the current state of the curve. The initial set of control points have no restrictions on location and may be placed anywhere and may be spaced arbitrarily far apart.

In order to generate/modify a curve according to a method consistent with the present disclosure, the system relies on a method of generating mathematical functions from a set of control points. In one embodiment, the system incorporates cubic spline interpolation to create a curve given a set of control points. The system further includes methods of determining the manner in which to move control points in response to user input. In particular, each user input (e.g. touch event, mouse action) may result in movement of a control point of the curve being manipulated to a new location, thereby resulting in a new curve being generated from the resulting list of control points via cubic spline interpolation.

### EXAMPLE METHOD 1

In one embodiment, when a user first touches or clicks on a graph (e.g. initial input), the system is configured to identify the control point of the curve having an x-coordinate closest to the initial input. Upon identifying a control point, the control point's y-coordinate adjusts in relation to additional user input (e.g. finger swipe, mouse pointer drag). In particular, the control point's y-coordinate changes so to follow movement of the user input. It should be noted that in this embodiment, the x-coordinate of the control point remains constant with no change during modification, as the system only monitors the vertical position of the user input with the graph. It should be noted that this exemplary method may be used to achieve the manipulation of the curve described and shown in FIGS. 3 and 4.

### EXAMPLE METHOD 2

In another embodiment, when a user first touches or clicks on the graph (e.g. initial input) the system is configured to identify the nearest control point associated with the initial user input. This can be accomplished by either identifying the control point having an x-coordinate closest to the initial user input or identifying the control point having both an the x- and y-coordinates closet to the initial user input.

Upon identifying a control point, the entire control point (both x- and y-coordinates) is moved to correspond to subsequent user input after the initial user input (e.g. finger swipe, mouse pointer drag) and fixed in a position where the user input is finished (e.g., when the user picks up his finger or releases the mouse button). It should be noted that this exemplary method may be used to achieve the manipulation of the curve described and shown in FIGS. 3 and 4.

### EXAMPLE METHOD 3

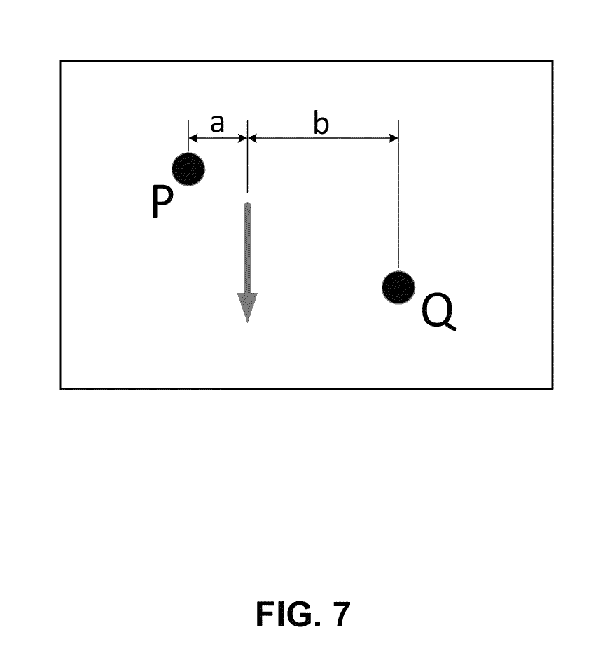

In another embodiment, when a user first touches or clicks on the graph (e.g. initial input) the system is configured to identify the nearest two control points associated with the initial user input. If the initial user input has an x-coordinate of A, then the system is configured to identify: (1) a control point having the largest x-coordinate less than A; and (2) a control point with the smallest x-coordinate greater than A. As the user continues to provide user input (e.g. drags their finger or mouse pointer across the screen), the y-coordinates of the identified control points are relocated so as to approach the y-coordinate of the user input (e.g. pointer of mouse). In particular, the y-coordinates are moved by an amount proportional to their distance from the initial user input. This is illustrated in FIG. 7, a graphic representation of control points of a curve of a dynamic graph consistent with the present disclosure.

As shown in FIG. 7, two identified control points are labeled P and Q. The initial user input is illustrated at beginning of vertical arrow. As shown, distance “a” represents the difference between the x-coordinate of the initial user input and control point P and distance “b” represents the difference between the x-coordinate of the initial user input and control point Q. In the event that the initial user input was closer to control point P, then control point P's y-coordinate will move further than control point Q's y-coordinate in response to the user interaction. In such an interaction, the control point P will move vertically downward by an amount determined by distance “a” and/or distance “b”, and the control point Q will move vertically upward by an amount determined by distance “a” and/or distance “b”.

The amount to move control points P and/or Q can be any function of the distances “a” and “b”, and the starting locations of control points P and Q. For example, consider the following formula :

P moves by an amount equal to [b/(a+b)]̂n and Q moves by an amount equal to [a/(a+b)]̂n, where n may be any number such as 0, 0.1, 1, 2, or 100.

In practice, n represents the sensitivity of the graph to touches. Any other functions of the distances “a” and “b”. It should be noted that this exemplary method may be used to achieve the manipulation of the curve described and shown in FIGS. 3 and 4.

### EXAMPLE METHOD 3(A)

In another embodiment, when a user first touches or clicks on the graph (e.g. initial input) the system is configured to compute the distance from the initial point of the graph (associated with the initial user input) to every control point of the graph. This distances may be computed based on a comparison of only the x-coordinate of each control point with the initial point, only the y-coordinate of each control point, or a function that includes both the x- and y-coordinates in the computation.

Similar to Example Method 3, one or more identified control points are moved by an amount based on the computed distances. However, rather than selecting one or two control points to move, all of the control points may be moved. The amount to move each control point, similar to Example Method 3, can be any function of the distances computed.

### EXAMPLE METHOD 4

In another embodiment, one or two control points are identified and selected to be moved in response to user input, in a fashion similar to the method described in Example Method 3. However, as the user drags the pointer across the screen, the system is configured to recompute the selection of the two control points, using the same technique described in Example Method 3, every time the pointer moves. Thus, although control points only ever move vertically, the user can drag their finger horizontally and alter many different control points in a single motion. It should be noted that this exemplary method may be used to achieve the manipulation of the curve described and shown in FIGS. 3 and 4, as well as FIGS. 5 and 6.

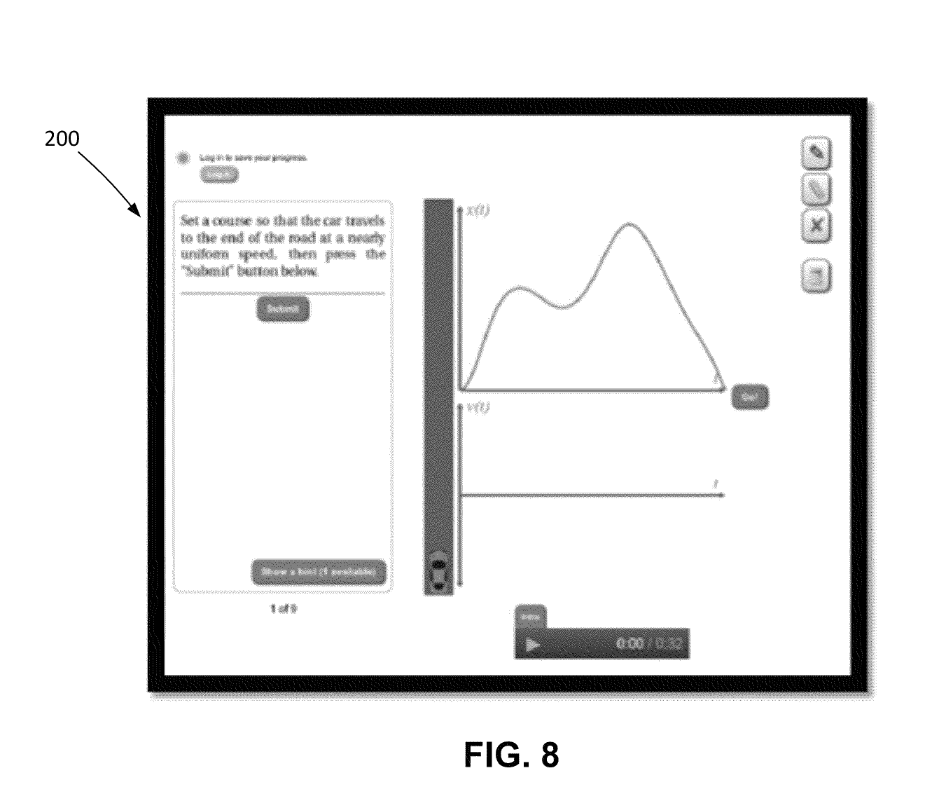

FIG. 8 is a screenshot 200 of a user interface of a drawing program consistent with various embodiments of the present disclosure. As shown, the user interface provides a user with the ability to manipulate the curve. The system and method consistent with the present disclosure may be implemented in a variety of different application programs, and is not limited to drawing programs. For example, as shown in the screenshot, the system and method of the present disclosure may be implemented in educational-related programs.

As used in any embodiment herein, the term “module” may refer to software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices. “Circuitry”, as used in any embodiment herein, may comprise, for example, singly or in any combination, hardwired circuitry, programmable circuitry such as computer processors comprising one or more individual instruction processing cores, state machine circuitry, and/or firmware that stores instructions executed by programmable circuitry. The modules may, collectively or individually, be embodied as circuitry that forms part of a larger system, for example, an integrated circuit (IC), system on-chip (SoC), desktop computers, laptop computers, tablet computers, servers, smart phones, etc.

Any of the operations described herein may be implemented in a system that includes one or more storage mediums having stored thereon, individually or in combination, instructions that when executed by one or more processors perform the methods. Here, the processor may include, for example, a server CPU, a mobile device CPU, and/or other programmable circuitry.

Also, it is intended that operations described herein may be distributed across a plurality of physical devices, such as processing structures at more than one different physical location. The storage medium may include any type of tangible medium, for example, any type of disk including hard disks, floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, Solid State Disks (SSDs), magnetic or optical cards, or any type of media suitable for storing electronic instructions. Other embodiments may be implemented as software modules executed by a programmable control device. The storage medium may be non-transitory.

As described herein, various embodiments may be implemented using hardware elements, software elements, or any combination thereof. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth.

Reference throughout this specification to “one embodiment” or “an embodiment” means that a particular feature, structure, or characteristic described in connection with the embodiment is included in at least one embodiment. Thus, appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

What is claimed is:

1. A system for generation and manipulation of a dynamic graph, said system comprising:
a computing device for executing and running an application, said computing device comprising;
a user interface associated with said application, said user interface configured to allow a user to interact with said application based on user input; and
a display for displaying said user interface.

2. The system of claim 1, wherein said application is a drawing program.

3. The system of claim 2, wherein said user interface is configured to allow said user to manipulate a curve in a dynamic graph based on user input with said user interface.

4. The system of claim 3, wherein said user input is selected from the group consisting of a touch event, a mouse event and a keypad/keyboard event.

5. The system of claim 4, wherein said computing device further comprises a touch detection module configured to generate touch input data in response to one or more touch events on said display and to transmit said touch input data to said user interface.

6. The system of claim 3, wherein said user interface is configured to identify initial user input with said dynamic graph and curve thereon.

7. The system of claim 6, wherein said user interface is configured to identify at least one control point of said curve associated with said initial user input and adjust said at least one control point based on said user input.

8. The system of claim 7, wherein said at least one control point has an x-coordinate closest to said initial user input.

9. The system of claim 7, wherein said at least one control point has x- and y-coordinates closest to said initial user input.

10. A method for generating and manipulating a dynamic graph, the method comprising:
providing a dynamic graph having at least one curve presented thereon;
detecting user interaction with said dynamic graph and curve thereon based on user input; and
modifying said at least one curve based on said user input.

11. The method of claim 10, wherein said user input is selected from the group consisting of a touch event, a mouse event and a keypad/keyboard event.

12. The method of claim 10, identifying initial user input with said dynamic graph and curve thereon.

13. The method of claim 12, identifying at least one control point of said curve associated with said initial user input and adjusting said at least one control point based on said user input.

14. The method of claim 13, wherein said at least one control point has an x-coordinate closest to said initial user input.

15. The method of claim 13, wherein said at least one control point has x- and y-coordinates closest to said initial user input.
